(19) United States
(12) Patent Application Publication
(10) Pub. No.: US 2025/0113749 A1
(43) Pub. Date: Apr. 10, 2025

(54) SWEEP FOR CULTIVATING SOIL IN A FIELD

(71) Applicant: CENTRAL WISCONSIN AG. SERVICES LLC, Alma Center, WI (US)

(72) Inventor: Lucas Dale Peterson, Black River Falls, WI (US)

(21) Appl. No.: 18/481,080

(22) Filed: Oct. 4, 2023

(51) Int. Cl. A01B 15/04

(52) U.S. Cl. CPC A01B 15/04

(57) ABSTRACT

A sweep for cultivating soil in a field, the sweep comprising opposite left and right wings joined at a center line to form a V-shaped symmetrical body with leading edges. The body having a top surface and a bottom surface, with each wing having a wing tip, the wings forming a front nose, with the leading edge of each wing being spaced rearwardly from the nose. The sweep also includes a neck extending upwardly from the center line of the symmetrical body, a tungsten carbide nose plate attached to the body top surface at the front nose, and a pair of leading-edge tungsten carbide edge plates, one of each is attached to a respective wing leading edge.

### BACKGROUND

This disclosure relates to a tool for improved soil tillage, and particularly to an agricultural field cultivator sweep with enhanced durability.

Field cultivator sweeps are well known in the agricultural industry. These sweeps are pulled through the ground to loosen the soil for seeding. These sweeps are also used to remove weeds which otherwise absorb nutrients and moisture from the soil.

Conventional filed cultivator sweeps have a V-shaped body formed by opposing wings, with a pointed nose on the body. The wings generally reside in a horizontal plane and have an upstanding neck which connects to a shank of the cultivator using bolts or other known attachment means, such as clamps, pins, screws, and welding. The sweeps are drawn through soil at a depth of a few inches below the surface.

In operation, the conventional cultivator sweeps do a reasonably good job of ripping weeds from the soil, while creating some loosened soil. The conventional cultivator sweeps wear out relatively quickly, however, resulting in the need for the machinery to be taken down for maintenance while new sweeps are installed. This adds time and difficulty to the growing process, especially when time is of the essence.

Therefore, there is a need for an improved filed cultivator sweep with increased durability so that less time is needed for maintenance and the installation of new sweeps.

### SUMMARY

Disclosed is a sweep for cultivating soil in a field, the sweep comprising opposite left and right wings joined at a center line to form a V-shaped symmetrical body with leading edges. The body has a top surface and a bottom surface, with each wing having a wing tip, the wings forming a front nose, with the leading edge of each wing being spaced rearwardly from the nose. The sweep also includes a neck extending upwardly from the center line of the symmetrical body, a tungsten carbide nose plate attached to the body top surface at the front nose, and a pair of leading-edge tungsten carbide edge plates, one of each is attached to a respective wing leading edge.

A primary objective of the present disclosure is the provision of a field cultivating sweep which does not have to be replaced as often.

These and other objectives have become apparent from the following description of the disclosure.

### BRIEF DESCRIPTION OF THE DRAWINGS

FIG. 1 is a side elevation view of the field cultivator sweep according to the present disclosure.

FIG. 2 is a view like FIG. 1 except with a nose plate and front edge plates spaced apart from the body of the sweep.

FIG. 3 is a cross section of one wing of the sweep taken along the line 3-3 in FIG. 1.

FIG. 4 is top view of the sweep of FIG. 1.

FIG. 5 is a side of the sweep of FIG. 1.

FIGS. 6A, 6B and 6C are photographs from a top elevational view showing the

sweep of this disclosure when new on the left, and the sweep of this disclosure after use in the middle, and a conventional prior art sweep on the right, after a field test of the sweeps to compare the wear after 2000 acres (approximately) of use.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof.

### DESCRIPTION OF THE PREFERRED EMBODIMENT

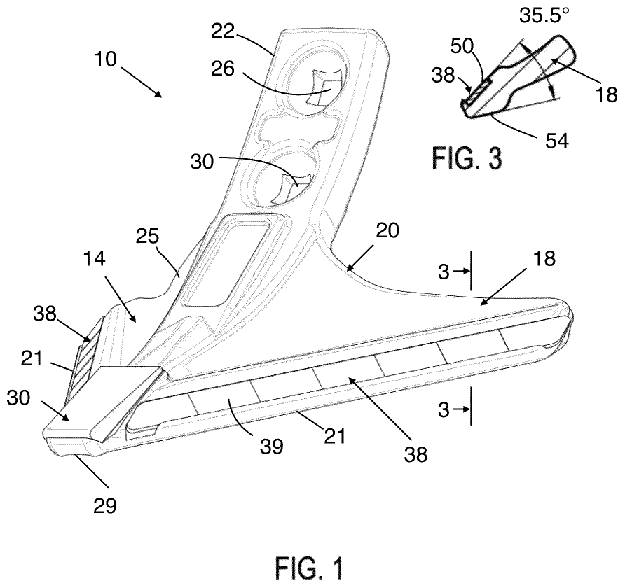

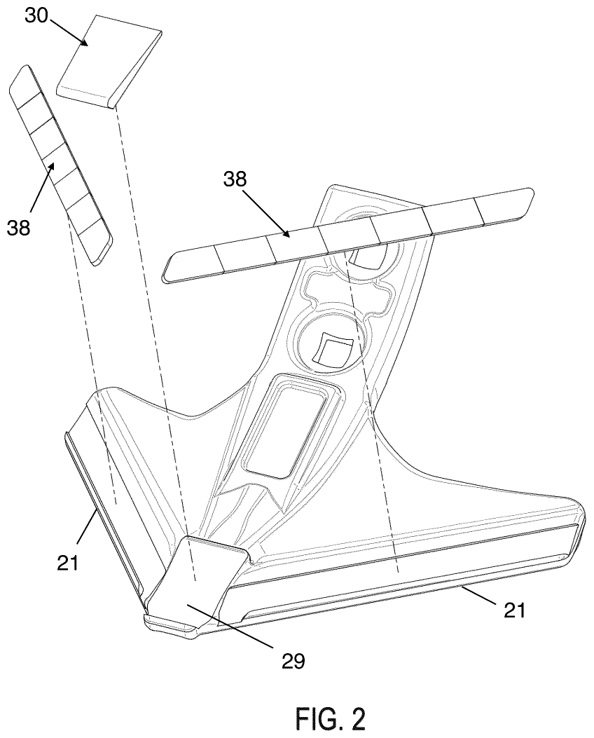

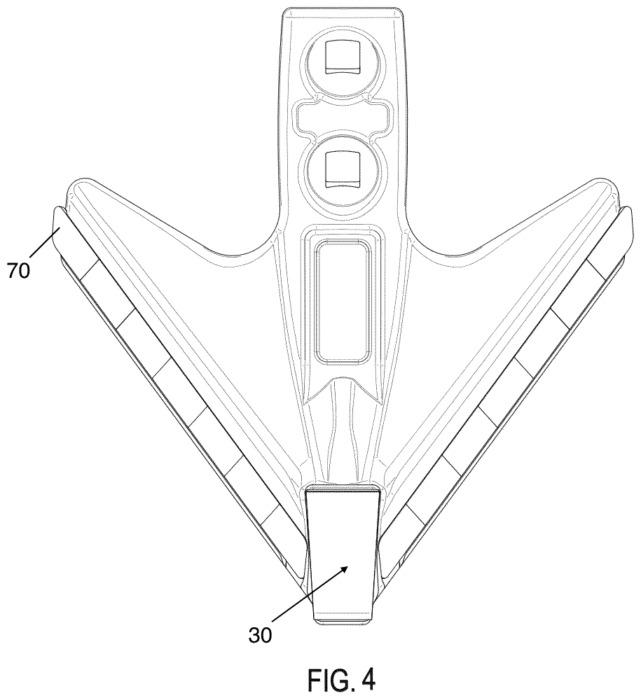

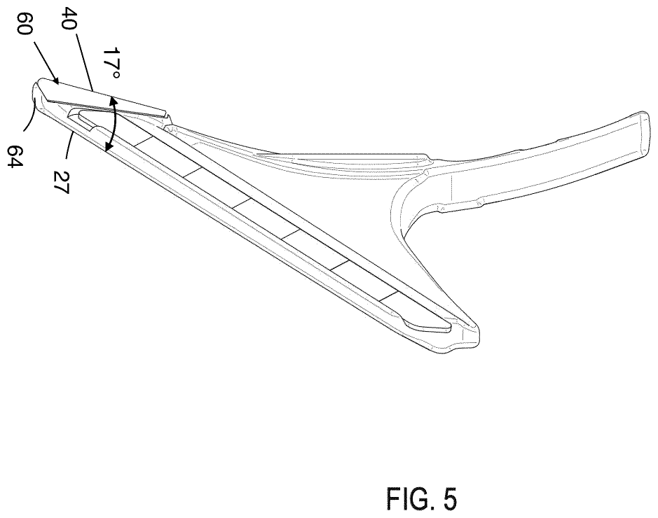

FIGS. 1-5 show a preferred embodiment of a sweep 10 for cultivating soil in a field in accordance with the present disclosure. The field cultivator sweep 10 includes a a first left wing 14 and an opposite second right wing 18 joined at a center line to form a V-shaped symmetrical wing body 20. The body 20 is made from 30 MNCR 85 steel and has a pair of leading edges 21, and an upstanding neck 22 at the rear of the body 20. The body has a top surface 25 and a bottom surface 27 (see FIG. 5), and the body 20 has a front nose 29 with the wings reward from the front nose 29.

The neck 22 is configured to attach to a shank (not shown) of a cultivator. To this end, the neck 22 may include a plurality of apertures to connect the cultivator sweep 10 to the shank. For example, the field cultivator sweep 10 is illustrated as having two apertures 26 and 30 to allow the field cultivator sweep 10 to connect to the shank by a pair of bolts (not shown). It is understood the above connecting method is merely exemplary as the field cultivator sweep 10 may be attached to the shank by a different method, for example, by clamps, pins, screws, and welding. Furthermore, the number of apertures illustrated in the drawings is not meant to be a limiting feature since some embodiments of the cultivator sweep 10 may include only a single aperture, more than two apertures, or even no apertures.

To improve the durability of the sweep, a tungsten carbide nose plate 30 is attached to the body top surface 25 at the front nose 29, and one each of a pair of leading-edge tungsten carbide edge plates 38 is attached to a top of a respective body leading edge 21. In a preferred embodiment, the grade of the tungsten carbide is BH40. The durability of the sweep 10 is further improved by the chosen angle of the nose plate 30 and the front edge plates 38. More particularly, the nose plate 30 has an upper surface 40 (see FIG. 5) that extends at about a 17-degree angle from the body bottom surface 27, and each of the edge plates 38 has an upper surface 50 that extends at about a 35.5-degree angle (see FIG. 3) from the respective leading edge bottom surface 54. Further, in the preferred embodiment, the sweep 10 is about 8.5 inches wide.

To further improve the durability of the sweep 10, the nose plate 30 is wedge shaped, with the wide base 60 (see FIG. 5) of the wedge-shaped nose plate 30 at the tip 64 of the front nose 29. A portion 70 (see FIGS. 1, 4 and 5) of each of the edge plates 38 extends outwardly from its respective wing tip 64.

In the preferred embodiment, each of the front edge plates 38 comprises a plurality of smaller plates 39 adjacent to each other.

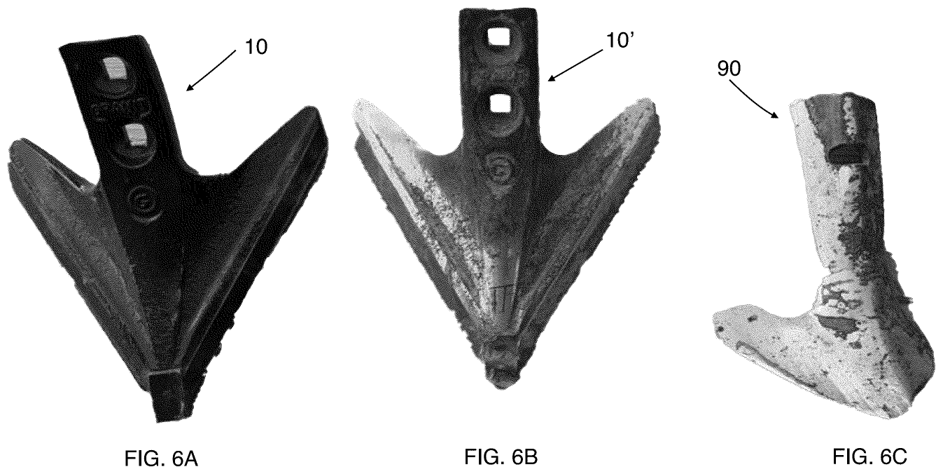

FIGS. 6A, 6B and 6C are photographs from a top elevational view showing the sweep 10 of this disclosure when new on the left, and the sweep 10′ of this disclosure after use in the middle, and a conventional prior art sweep 90 on the right, after a field test of the sweeps to compare the wear after 2000 acres (approximately) of use. This evidence shows how the sweep 10 of this disclosure is significantly more durable than a conventional sweep 90.

Various other features of this disclosure are set forth in the following claims.

1. A sweep for cultivating soil in a field, the sweep comprising:
opposite left and right wings joined at a center line to form a V-shaped symmetrical body with leading edges, the body having a top surface and a bottom surface, with each wing having a wing tip, the wings forming a front nose, with the leading edge of each wing being spaced rearwardly from the nose,
a neck extending upwardly from the center line of the symmetrical body, the neck being adapted for mounting the sweep to a cultivator,
a tungsten carbide nose plate attached to the body top surface at the front nose, and
a pair of leading-edge tungsten carbide edge plates, one of each is attached to a top of a respective wing leading edge.

2. The sweep according to claim 1 wherein the nose plate is attached to the nose by brazing.

3. The sweep according to claim 1 wherein the nose plate is wedge shaped, with the wide base of the wedge-shaped nose plate at the tip of the nose.

4. The sweep according to claim 1 wherein a portion of each of the edge plates extends outwardly from its respective wing tip.

5. The sweep according to claim 1 wherein the nose plate has an upper surface that extends at about a 17-degree angle from the front nose bottom surface.

6. The sweep according to claim 1 wherein each of the edge plates has an upper surface that extends at about a 35.5-degree angle from the respective leading edge bottom surface.

7. The sweep according to claim 1 wherein each of the front edge plates comprises a plurality of smaller plates adjacent to each other.

8. The sweep according to claim 1 wherein the body from wing tip to wing tip is about 8.5 inches wide.

9. A sweep for cultivating soil in a field, the sweep comprising:
opposite left and right wings joined at a center line to form a V-shaped symmetrical body with leading edges, the body having a top surface and a bottom surface, with each wing having a wing tip, the wings forming a front nose, with the leading edge of each wing being spaced rearwardly from the nose, and the body from wing tip to wing tip is about 8.5 inches wide,
a neck extending upwardly from the center line of the symmetrical body, the neck being adapted for mounting the sweep to a cultivator,
a tungsten carbide nose plate attached to the body top surface at the front nose, the nose plate being wedge shaped, with the wide base of the wedge-shaped nose plate at the tip of the nose, and the nose plate having an upper surface that extends at about a 17-degree angle from the front nose bottom surface, and
a pair of leading-edge tungsten carbide edge plates, one of each is attached to a top of a respective wing leading edge, a portion of each of the edge plates extends outwardly from its respective wing tip, and the edge plates each have an upper surface that extends at about a 35.5-degree angle from the respective leading edge bottom surface.

10. The sweep according to claim 9 wherein the nose plate is attached to the nose by brazing.

11. The sweep according to claim 9 wherein each of the front edge plates comprises a plurality of smaller plates adjacent to each other.
